(19) United States
(12) Patent Application Publication
(10) Pub. No.: US 2013/0001951 A1
(43) Pub. Date: Jan. 3, 2013

(54) Tube-Type Wind Power Generator

(76) Inventors: Chang-Hsien Tai, Neipu Hsiang (TW); Jr-Ming Miao, Neipu Hsiang (TW); Jyh-Tong Teng, Neipu Hsiang (TW); Shi-Wei Lo, Neipu Hsiang (TW); Uzu-Kuei Hsu, Neipu Hsiang (TW); Liang-Ji Chang, Neipu Hsiang (TW)

(21) Appl. No.: 13/213,140

(22) Filed: Aug. 19, 2011

(30) Foreign Application Priority Data
Jun. 28, 2011 (TW) 100122653

(51) Int. Cl. F03D 9/00

(52) U.S. Cl. 290/55

(57) ABSTRACT

A tube-type wind power generator includes an intake tube, an exhaust tube and a wind power generation device. The intake tube has a first end, a second end and an intake air channel, wherein the first end has a plurality of air inlets. A narrow portion is formed between the first and second ends. The exhaust tube surrounds the intake tube and has an opening end and a closed end, wherein the opening end has a plurality of windward openings and a plurality of air-guiding openings. An exhaust channel is defined between the exhaust tube and the intake tube. A gap is defined between the closed end of the exhaust tube and the second end of the intake tube. The wind power generation device has an axial-flow type impeller and a generator, wherein the axial-flow type impeller is disposed at the narrow portion of the intake tube.

### BACKGROUND OF THE INVENTION

1. Field of the Invention

The present invention generally relates to a wind power generator and, more particularly, to a tube-type wind power generator.

2. Description of the Related Art

Wind power has been a very important renewable energy since it is sustainable and can be used to generate electricity without causing anything harmful to environment. In wind power generation, natural wind can drive an axial-flow type impeller to rotate. In turn, the rotating impeller can drive a generator to generate electricity. Since wind power generation uses natural wind to generate electricity, there is always enough wind energy to drive the generator.

A conventional wind power generator comprises an axial-flow type impeller and a generator. As an example of horizontal wind turbine, the impeller is set in a direction facing the wind in order to drive the impeller in a most efficient way. Then, the rotating impeller generates and sends a mechanical energy to a speed gear of the generator. Finally, the generator converts the mechanical energy into electricity energy, thus completing electricity generation process.

The impeller is usually set in the air to be driven by wind. However, the impeller cannot be efficiently driven when the wind is unstable or too weak. Therefore, the impeller cannot generate enough mechanical energy for electricity generation.

When the wind is too strong, the impeller will rotate in a very fast speed. In this case, the frame of the wind power generator can break due to fast rotation of the impeller. In light of this problem, a braking device may be used to reduce the rotation speed of the impeller. However, use of the braking device will reduce the wind power utilization rate, leading to an inefficient electricity generation.

### SUMMARY OF THE INVENTION

It is therefore the primary objective of this invention to provide a tube-type wind power generator that can receive air in an efficient way and increase the air speed, thereby attaining electricity generation efficiency.

It is another objective of this invention to provide a tube-type wind power generator that has a high wind power utilization rate even when the wind is at a high speed.

The invention discloses a tube-type wind power generator comprising an intake tube, an exhaust tube and a wind power generation device. The intake tube has a first end, a second end and an intake air channel, wherein the first end has a plurality of air inlets. A narrow portion is formed between the first and second ends. The exhaust tube surrounds the intake tube and has an opening end and a closed end, wherein the opening end has a plurality of windward openings and a plurality of air-guiding openings. An exhaust channel is defined between the exhaust tube and the intake tube. A gap is defined between the closed end of the exhaust tube and the second end of the intake tube such that the intake air channel is allowed to communicate with the exhaust channel. The wind power generation device has an axial-flow type impeller and a generator, wherein the axial-flow type impeller is disposed at the narrow portion of the intake tube.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a tube-type wind power generator according to a preferred embodiment of the invention.

FIG. 2 is a cross-sectional view of the tube-type wind power generator of the invention.

FIG. 3 shows an air path of the tube-type wind power generator of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

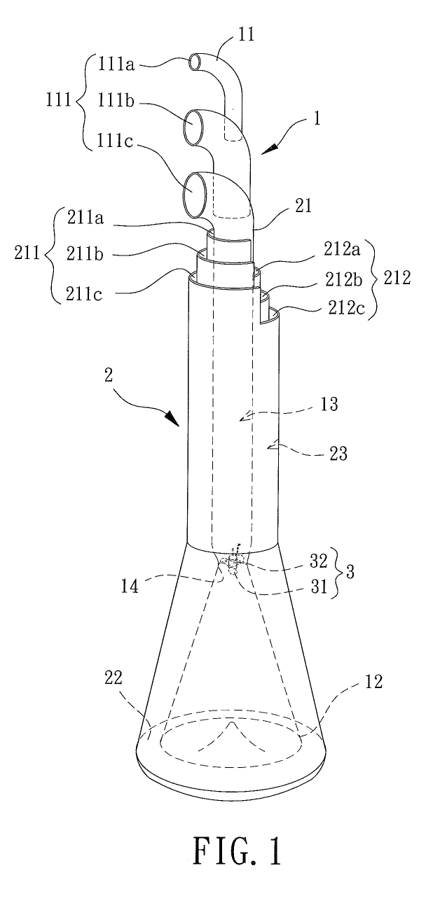

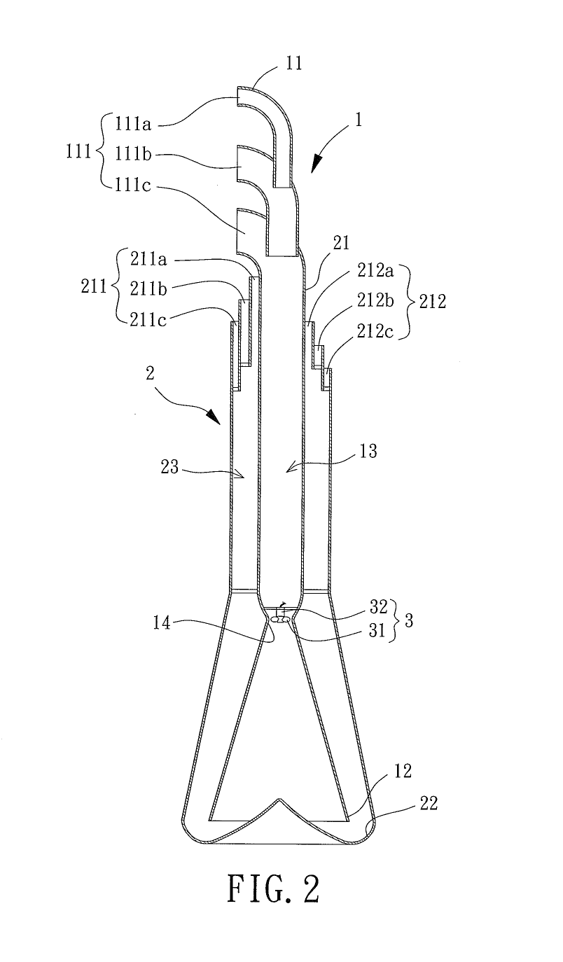

Referring to FIGS. 1 and 2, a tube-type wind power generator comprising an intake tube 1, an exhaust tube 2 and a wind power generation device 3 is disclosed according to a preferred embodiment of the invention. The intake tube 1 is disposed in the exhaust tube 2. The wind power generation device 3 is disposed in the intake tube 1.

The intake tube 1 is a hollow tube having a first end 11 and a second end 12. The first end 11 has a plurality of air inlets 111. In this embodiment, the first end 11 has a first air inlet 111a, a second air inlet 111b and a third air inlet 111c. More air can be received by arranging three air inlets. The intake tube 1 further comprises an intake air channel 13 and a narrow portion 14. The narrow portion 14 is a part of the intake air channel 13 that has a smallest cross-sectional area between the first end 11 and the second end 12 of the intake tube 1. The intake air channel 13 has a fixed cross section from the first end 11 to a predetermined location near the narrow portion 14. The cross section of the intake air channel 13 starts to reduce in a gentle way from the predetermined location to the narrow portion 14. After the narrow portion 14, the cross section of the intake air channel 13 starts to increase all the way to the second end 12.

The exhaust tube 2 has an opening end 21 and a closed end 22. The opening end 21 has a plurality of windward openings 211 and a plurality of air-guiding openings 212. In the embodiment, the opening end 21 has a first windward opening 211a, a second windward opening 211b and a third windward opening 211c, a first air-guiding openings 212a, a second air-guiding openings 212b and a third air-guiding openings 212c. These windward openings and air-guiding openings can allow more air to be expelled therethrough. The windward openings are higher than the air-guiding openings 212. An exhaust channel 23 is defined between the exhaust tube 2 and the intake tube 1. A gap is defined between the closed end 22 of the exhaust tube 2 and the second end 12 of the intake tube 1, such that the intake air channel 13 can communicate with the exhaust channel 23.

The wind power generation device 3 has an axial-flow type impeller 31 and a generator 32. The impeller 31 is disposed at the narrow portion 14 of the intake tube 1. In particular, the impeller 31 is preferably set in a direction facing the intake air so that the impeller 31 can be driven in an efficient way. The rotating impeller 31 may generate a mechanical energy that can be converted into electricity energy by the generator 32. Finally, the electricity energy is stored in an external storage device to complete electricity generation.

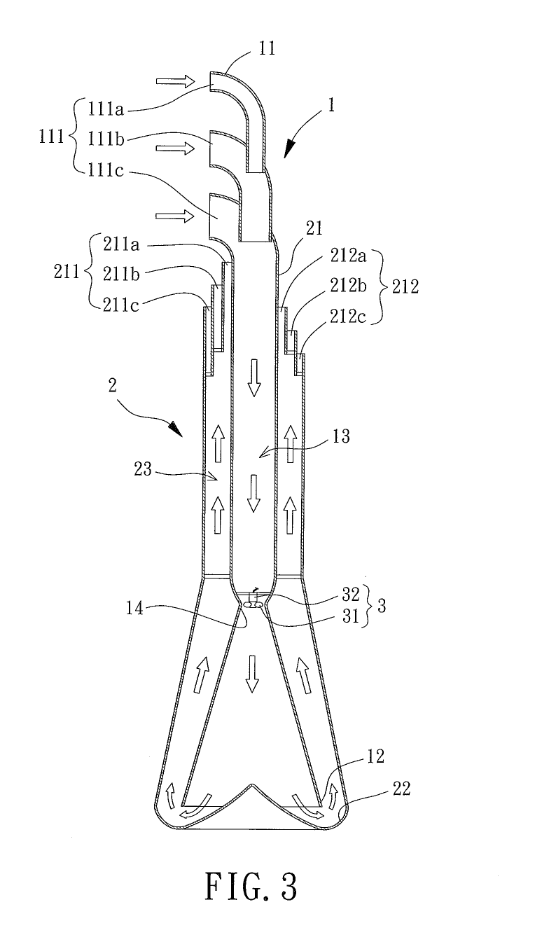

Referring to FIG. 3, the tube-type wind power generator of the invention can collect airflows via the air inlets 111, and the airflows can enter the intake air channel 13 and drive the wind power generation device 3 in the intake air channel 13. Then, the air can be expelled via the windward openings 211 and the air-guiding openings 212 of the opening end 21. Specifically, the air inlets 111 of the intake tube 1 are preferably set in a direction facing the wind to best receive the airflows. Then, the intake air will travel in the intake air channel 13 and passes through the narrow portion 14. Since the narrow portion 14 has a smallest cross section, the intake air will be speeded up after the narrow portion 14. After the narrow portion 14, the intake air will have a smaller resistance all the way to the second end 12 due to the gradually-expanded cross section of the intake air channel 13. In such a structure, the intake air will flow to the second end 12 more smoothly. This structure can indirectly speed up the intake air passing through the narrow portion 14, thereby increasing the rotational speed of the impeller 31 at the narrow portion 14.

Since the intake air channel 13 communicates with the exhaust channel 23 (via the gap between the closed end 22 of the exhaust tube 2 and the second end 12 of the intake tube 1), the intake air in the intake air channel 13 will be expelled via the windward openings 211 and the air-guiding openings 212. The direction of the windward openings 211 and the air-guiding openings 212 can be adjusted according to wind direction. In a preferred case, the first windward opening 211a, second windward opening 211b and third windward opening 211c are set in a direction facing the wind. Thus, the air expelled at the windward openings 211 will be brought to the air-guiding openings 212. Since the air-guiding openings 212 are lower than the windward openings 211, the air from the windward openings 211 will interact with the air of the air-guiding openings 212, creating a low air pressure at the air-guiding openings 212. This will enhance the air-pulling effect of the air-guiding openings 212. Thus, the air in the tube-type wind power generator can be pushed out by the intake air and pulled out by the air-pulling effect at the same time, thereby speeding up the air circulation. Thus, overall electricity generation efficiency is improved.

The tube-type wind power generator of the invention can receive airflows in an efficient way and therefore increase the rotation speed of an impeller disposed in an intake air channel thereof. Thus, overall electricity generation efficiency is improved.

The tube-type wind power generator of the invention does not need to slow down an impeller for protecting a frame of the tube-type wind power generator. Thus, better wind power utilization rate is provided.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A tube-type wind power generator, comprising:
an intake tube having a first end, a second end and an intake air channel, wherein the first end has a plurality of air inlets, and a narrow portion is formed between the first and second ends;
an exhaust tube surrounding the intake tube and having an opening end and a closed end, wherein the opening end has a plurality of windward openings and a plurality of air-guiding openings, an exhaust channel is defined between the exhaust tube and the intake tube, a gap is defined between the closed end of the exhaust tube and the second end of the intake tube such that the intake air channel is allowed to communicate with the exhaust channel; and
a wind power generation device having an axial-flow type impeller and a generator, wherein the axial-flow type impeller is disposed at the narrow portion of the intake tube.

2. The tube-type wind power generator as claimed in claim 1, wherein the narrow portion is a part of the intake air channel that has a smallest cross-sectional area.

3. The tube-type wind power generator as claimed in claim 2, wherein the cross section of the intake air channel starts to increase all the way to the second end of the intake tube.

4. The tube-type wind power generator as claimed in claim 1, wherein the air-guiding openings are lower than the windward openings.
